(19) United States
(12) Patent Application Publication
(10) Pub. No.: US 2013/0335010 A1
(43) Pub. Date: Dec. 19, 2013

(54) CONNECTOR AND CONTROL CHIP

(71) Applicant: NUVOTON TECHNOLOGY CORPORATION, Hsinchu Science Park (TW)

(72) Inventors: Chun-Yi WU, Hsinchu Science Park (TW); Chia-Ching LU, Hsinchu Science Park (TW); Ping-Ying CHU, Hsinchu Science Park (TW)

(73) Assignee: NUVOTON TECHNOLOGY CORPORATION, Hsinchu Science Park (TW)

(21) Appl. No.: 13/831,327

(22) Filed: Mar. 14, 2013

(30) Foreign Application Priority Data
Jun. 19, 2012 (TW) 101211770

(51) Int. Cl. H02J 7/00

(52) U.S. Cl. CPC H02J 7/0042
USPC 320/107

(57) ABSTRACT

A connector is provided. In one embodiment, the connector conforms to a data communication standard, and is connected to a cable, and comprises a contact opening and a control chip. The contact opening comprises a plurality of first contacts on a first side for performing a data communication process, and a plurality of second contacts on a second side for performing a rapid charging process. The control chip is coupled between the contact opening and the cable, and couples the second contacts to a downstream power port of the cable when the second contacts of the contact opening is coupled to a host connector of a host.

### CROSS REFERENCE TO RELATED APPLICATIONS

This Application claims priority of Taiwan Patent Application No. 101211770, filed on Jun. 19, 2012, the entirety of which is incorporated by reference herein.

### BACKGROUND OF THE INVENTION

1. Field of the Invention

The invention relates to communication devices, and more particularly to data transmission devices.

2. Description of the Related Art

A universal serial bus (USB) is a serial bus standard for connecting a computer system to peripheral devices. A USB interface is widely used for data communication of personal computers and mobile devices. A USB interface supports hot plugging and plug-and-play functions. When a peripheral device is coupled to a host via a USB interface, the host automatically loads driving software corresponding to the peripheral device after the host detects the existence of the peripheral device. The USB interface is therefore more convenient for a user to use than a PCI interface or an ISA interface.

Due to the convenience of the USB interface, more and more handheld devices now support the USB interface, such as cell phones, digital cameras, and tablet personal computers. A handheld device has a limited amount of power and must be frequently charged. A handheld device with a USB interface ordinarily supports power charging via the USB interface. There are two methods for charging via a USB interface. According to a first charging method, a USB port of an AC adapter is connected, via a USB cable, to a handheld device to charge the handheld device. According to a second charging method, a USB port of a host is connected, via a USB cable, to a handheld device to charge the handheld device.

When an AC adapter is used to charge a handheld device, a high charging current is provided by the AC adapter, and a charging time period is short. When a host is used to charge a handheld device via a USB interface, a charging current level provided by the host is ordinarily tower than that provided by the AC adapter, and a charging time period is longer than that corresponding to the AC adapter. If a host can provide a high charging current level to charge the handheld device, the charging time period would be shortened. Thus, a USB connector is provided to support a rapid charging function.

### BRIEF SUMMARY OF THE INVENTION

The embodiments of present invention provide a connector and a control chip. In one embodiment, the connector conforming to a data communication standard, is connected to a cable, and comprises a contact opening and a control chip. The contact opening comprises a plurality of first contacts on a first side for performing a data communication process, and a plurality of second contacts on a second side for performing a rapid charging process. The control chip is coupled between the contact opening and the cable, and couples the second contacts o a downstream power port of the cable when the second contacts of the contact opening is coupled to a host connector of a host.

In another embodiment, the control chip comprises a charging determination module and a power supply module. When a plurality of first contacts on a first side of a contact opening coupled to the control chip are coupled to a host connector of a host, the charging determination module performs a data transmission process conforming to a data communication standard. When a plurality of second contacts on a second side of the contact opening are coupled to the host connector, the power supply module couples the second contacts to a downstream power port of a cable to perform a raid charging process.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of a system according to the invention;

FIG. 2A is a schematic diagram of a top side of a USB connector according to the invention;

FIG. 2B is a schematic. diagram of a bottom side of a USB connector according to the invention;

FIG. 3 is a circuit diagram of a control chip according to the invention;

FIG. 4 is a flowchart of an operation method for a control chip according to the invention;

FIG. 5 is a circuit diagram of another embodiment of a control chip comprised by a USB connector according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

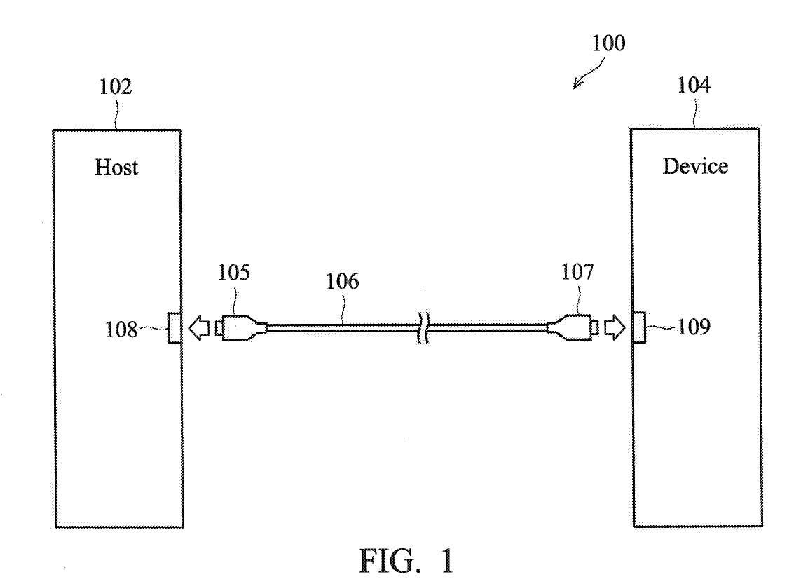

Referring to FIG. 1, a block diagram of a system 100 according to the embodiment of present invention is shown. The system 100 comprises a host 102, a device 104, and a cable 106. The host 102 is connected to the device 104 via the cable 106. In one embodiment, the device 104 is a handheld device, such as a cell phone or a digital camera. In one embodiment, the cable 106 is a cable conforming to a universal serial bus (USB) standard. The cable 106 comprises two connectors 105 and 107. The connector 107 can be a microUSB connector, a miniUSB connector, a standard USB connector, or a customized connector such as a 30 pin connector suitable for an Apple handheld device. In one embodiment, the connector 107 is a plug which can be inserted into a USB receptacle 109 of the device 104, wherein the USB receptacle 109 can be a microUSB receptacle, a miniUSB receptacle, or a standard USB receptacle, or a customized receptacle such as a receptacle suitable for Apple handheld device. The connector 105 is a USB connector manufactured according to the embodiment of present invention. The host 102 comprises a host connector 108. In one embodiment, the host connector 108 is a USB receptacle. In one embodiment, the connector 105 is a USB plug which can be inserted into a USB receptacle 108 of the host 102.

In one embodiment, the USB connector 105 has a first side such as top side and a second side such as bottom side and comprises a control chip. When a user inserts the USB connector 105 to the host connector 108 with the top side upward, the control chip uses the cable 106 to perform a data transmission process between the host 102 and the device 104. In addition to the data transmission process, a charging process with a charging current with a level lower than 500 mA can be simultaneously performed. When a user inserts the USB connector 105 to the host connector 108 with a bottom side upward, the control chip uses the USB cable 106 to perform a rapid charging process to transmit power from the host 102 to the device 104. The user can therefore determine whether a data transmission process or a rapid charging process is performed by inserting the USB connector 105 to the host connector 108 with the top side upward or the bottom side upward. The aforementioned embodiment in which the control chip is disposed in the USB connector 105 is only an embodiment of the invention. According to another embodiment, the control chip can be disposed in, for example, USB cable 106 or other components, and the control chip is electrically coupled to the connector 105. In addition, according to another embodiment, the connectors 105 and 107, the host connector 108, the device connector 109, and the cable 106 conform o a data transmission standard which is not the USB standard.

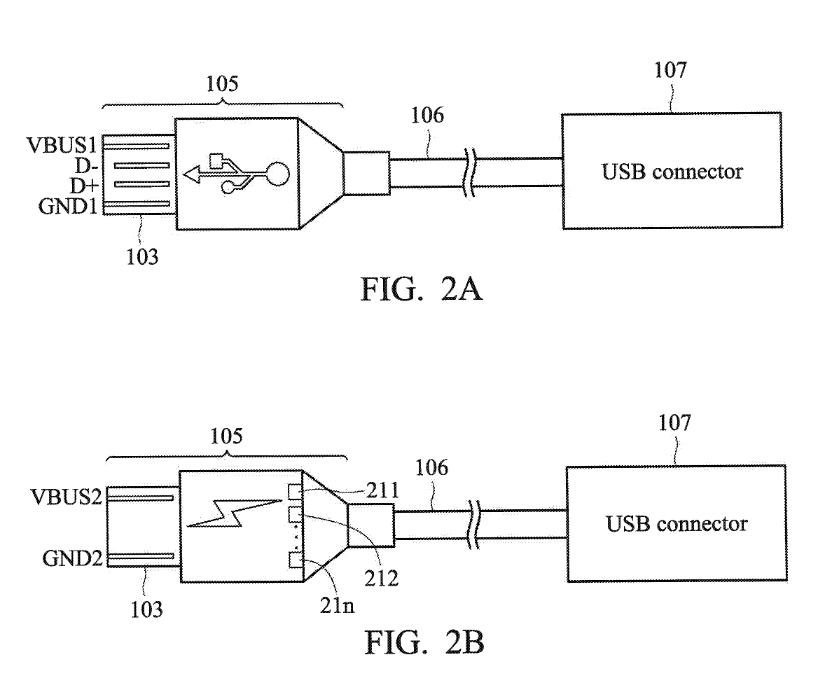

Referring to FIG. 2A, a schematic diagram of a top side of a USB connector 105 according to the embodiment of present invention is shown. The USB connector 105 can include a contact opening 103 to be coupled to the host connector 108. In one embodiment, the top side of the contact opening 103 of the USB connector 105 has a first power contact VBUS1, a first ground contact GND1, a positive data transmission contact D+, and a negative data transmission contact D−. When a user inserts the USB connector 105 to the host connector 108 with the top side upward, the contacts VBUS1, D−, D+, and GND1 are coupled to the host connector 108, and the control chip of the USB connector 105 then couples the contacts VBUS1, D−, D+, and GND1 to the USB cable 106 to perform a data transmission process. An ordinary charging process with a charging current level lower than 500 mA can be simultaneously performed to supply power to the device 104. In one embodiment, the top side of the USB connector 105 can include a data transmission indicator. When the data transmission process is performed, the control chip lights up the data transmission indicator to inform the user of the progress of the data transmission process.

Referring to FIG. 2B, a bottom side of a USA connector 105 according to the invention is shown. In one embodiment, the bottom side of the contact opening 103 of the USB connector 105 can include a second power contact VBUS2 and a second ground contact GND2. When the user inserts the USB connector 105 into the host connector 108 with the bottom side upward, the contacts VBUS2 and GND2 are coupled to the host connector 108, and the control chip couples the contacts VBUS2 and GND2 to the USA cable 106 to perform a rapid charging process.

In one embodiment, the bottom side of the USB connector 105 comprises a plurality of charging current indicators 211˜21n respectively corresponding o different charging current levels. When the rapid charging process is performed, the control chip comprised by the USB connector 105 lights up one of the charging current indicators according to the level of the charging current. In one embodiment, the charging current indicators 211˜21n can include a rapid charging indicator (to a corresponding charging current level ≧500 mA), a normal charging indicator (to a corresponding charging current level between 500 mA and 50 mA), and a no charging indicator (to a corresponding charging current level 50 mA). In one embodiment, the bottom side of the USA connector 105 further comprises an abnormal indicator, and the control chip lights up the abnormal indicator when an abnormal high current, an abnormal low voltage, or an abnormal high temperature occurs during the rapid charging process.

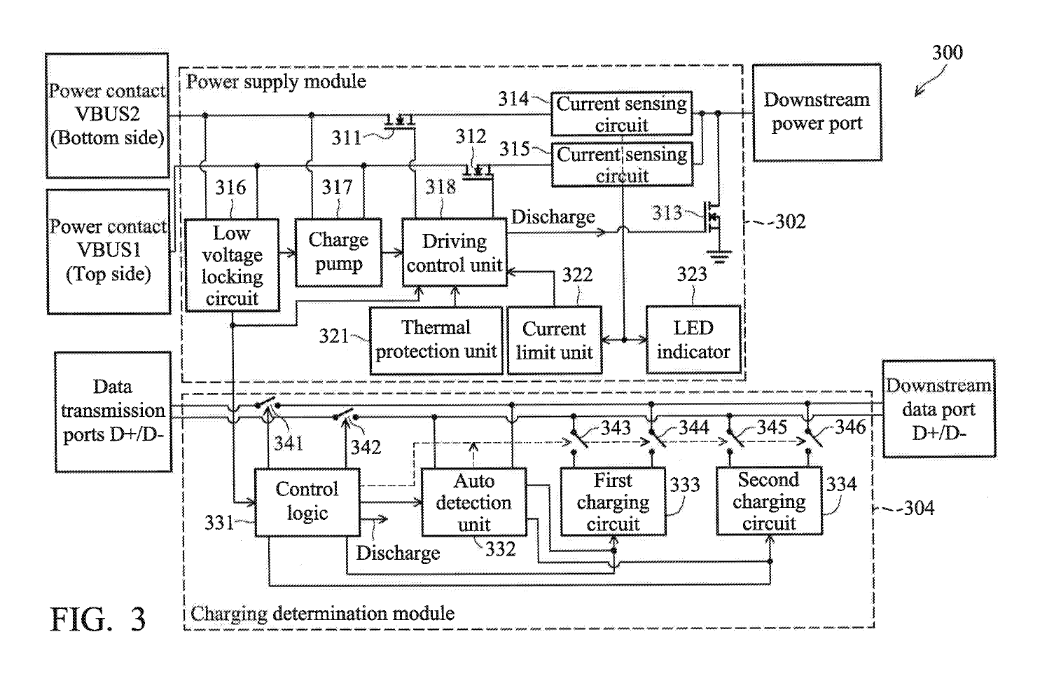

Referring to FIG. 3, a circuit diagram of a control chip 300 according to the embodiment of present invention is shown. in one embodiment, the control chip 300 can include a power supply module 302 and a charging determination module 304. The power supply module 302 is coupled between a first power contact VBUS1 on the top side of the USA connector 105, a second power contact VBUS2 on the bottom side of the USB connector 105, and a downstream power port of the cable 106. The charging determination module 304 is coupled between a positive data transmission port D+ and a negative transmission port D− on the top side of the USB connector 105 and downstream data ports of the cable 106. In one embodiment, the charging determination module 304 can include a control logic 331 and signal switches 341 and 342. The signal switch 341 is coupled between the positive data transmission contact D+ and a downstream positive data port of the cable 106. The signal switch 342 is coupled between the negative data transmission contact D− and a downstream negative data port of the cable 106. When e USB connector 105 is inserted into the host connector 108 with a top side upward, the first power contact VBUS1 is coupled to a power of the host connector 108, and the control logic 331 turns on the signal switch 341 to couple the positive data transmission contact D+ to the downstream positive data port of the cable 106, and turns on the signal switch 342 to couple the negative data transmission contact D− to the downstream negative data port of the cable 106 to perform a data transmission process. The driving control unit 318 also turns on the power switch 312 to couple the first power contact VBUS1 to the downstream power port of the cable 106, and a handheld device 104 is therefore coupled to the host 102 via the first power contact VBUS1 and is charged by a normal charging process.

In one embodiment, the power supply module 302 comprises a driving control unit 318 and power switches 311, 312, and 313. The power switch 312 is coupled between a first power contact VBUS1 on the top side of the USB connector 105 and a do s power port of the cable 106. The power switch 311 is coupled between a second power contact VBUS2 on the bottom side of the USB connector 105 and the downstream power port of the cable 106. When the USB connector 105 is inserted into the host connector 108 with the bottom side upward, the second power contact VBUS2 is coupled to the power of the host connector 108, and the driving control unit 318 turns on the power switch 311 to couple the second power contact VBUS2 to the downstream power port to perform a rapid charging process. The control logic 331 also turns off the signal switch 341 to decouple the positive data transmission contact D+ from the downstream positive data port of the cable 106, and turns off the signal switch 342 to decouple the negative data transmission contact D− from the downstream negative data port of the cable 106.

In one embodiment, the charging determination module 304 further comprises an auto detection unit 332, a first charging circuit 333, and a second charging circuit 334. The first charging circuit 333 supports a first charging mode, such as a dedicated charging port (DCP) mode. The second charging circuit 334 supports a second charging mode, such as an IDevice charging mode of the Apple company. When the USB connector 105 is inserted into the host connector 108, before the rapid charging process is performed, the control logic 331 couples a predetermined charging circuit (such as the first charging circuit 333) to the downstream data ports of the cable 106. The auto detection unit 332 then detects whether the device 104 coupled to the cable 106 supports a first charging mode or a second charging mode. If the device 104 supports the first charging mode, the control logic 331 turns on the switches 343 and 344 to couple the first charging circuit 333 to the downstream data ports of the cable 106. When the first charging circuit 333 is coupled to the downstream data ports of the cable 106, a rapid charging process is performed according to the first charging mode, and the device 104 is charged with a large charging current (≧500 mA). If the device 104 supports the second charging mode, the control logic 331 turns on the switches 345 and 346 to couple the second charging circuit 334 to the downstream data ports of the cable 106, and turns off the switches 343 and 344 to decouple the first charging circuit 333 from the downstream data ports. When the second charging circuit 334 is coupled to the downstream data ports of the cable 106, a rapid charging process is performed according to the second charging mode.

In one embodiment, the power supply module 302 further comprises a low voltage locking circuit 316, a charge pump 317, a thermal protection circuit 321, a current limit circuit 322, an LED indicator 323, and current sensing circuits 314 and 315. Before a rapid charging process is performed, when the power of the host 102 has not raised the voltage supplied to the power contacts VBUS1 and VBUS2 to a predetermined voltage level, the low voltage locking circuit 316 does not enable the charge pump 317 and the control logic 331. The charge pump 317 raises the voltage of the power supply routes between the power contacts VBUS1 and VBUS2 and the downstream power port to be a high level. The thermal protection unit 321 detects a temperature of the power supply module 302 and informs the driving control unit 318 of a high temperature if the high temperature is detected. The current sensing circuits 314 and 315 detect the level of the charging current flowing through the power supply routes between the power contacts VBUS1 and VBUS2 and the downstream power port. The LED indicator 323 lights up according to the charging current level detected by the current sensing circuits 314 and 315. When the charging current level detected by the current sensing circuits 314 and 315 is greater than a threshold level, the current limit unit 322 informs the driving control unit 318 of the high charging current level. When the thermal protection unit 321 and the current limit unit 322 informs the driving control unit 318 of an abnormal high current or an abnormal high temperature, the driving control unit 318 turns on the power switch 313 to couple the power supply route to ground to discharge the power supply route.

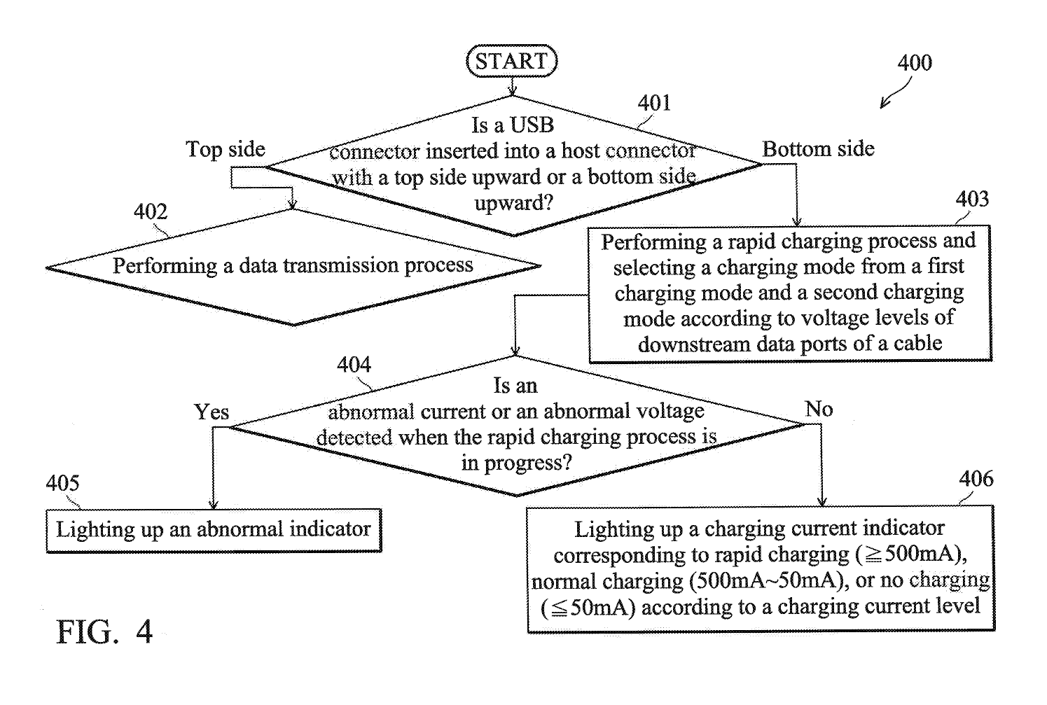

Referring to FIG. 4, a flowchart of an operation method 400 for a control chip 300 according to the embodiment of present invention is shown. First, the control chip 300 determines whether the USB connector 105 is inserted into the host connector 108 with a top side upward or a bottom side upward (step 401). If the USB connector 105 is inserted into the host connector 108 with the top side upward, the control chip 300 performs a data transmission process and a normal charging process (step 402). If the USB connector 105 is inserted into the host connector 108 with the bottom side upward, the control chip 300 performs a rapid charging process, and selects a charging mode from a first charging mode (such as a DCP charging mode) and a second charging mode (such as an iDevice charging mode) according to voltage levels of downstream data ports of the cable 106 (step 403). The control chip 300 then determines whether an abnormal current or an abnormal voltage is detected when the rapid charging process is performed (step 404). If the abnormal current or the abnormal voltage is detected when the rapid charging process is performed, the control chip 300 lights up an abnormal indicator to inform an user of the abnormal current or the abnormal voltage (step 405). If the abnormal current or the abnormal voltage is not detected when the rapid charging process is performed, the control chip 300 lights up a charging current indicator to a corresponding charging current level (step 406).

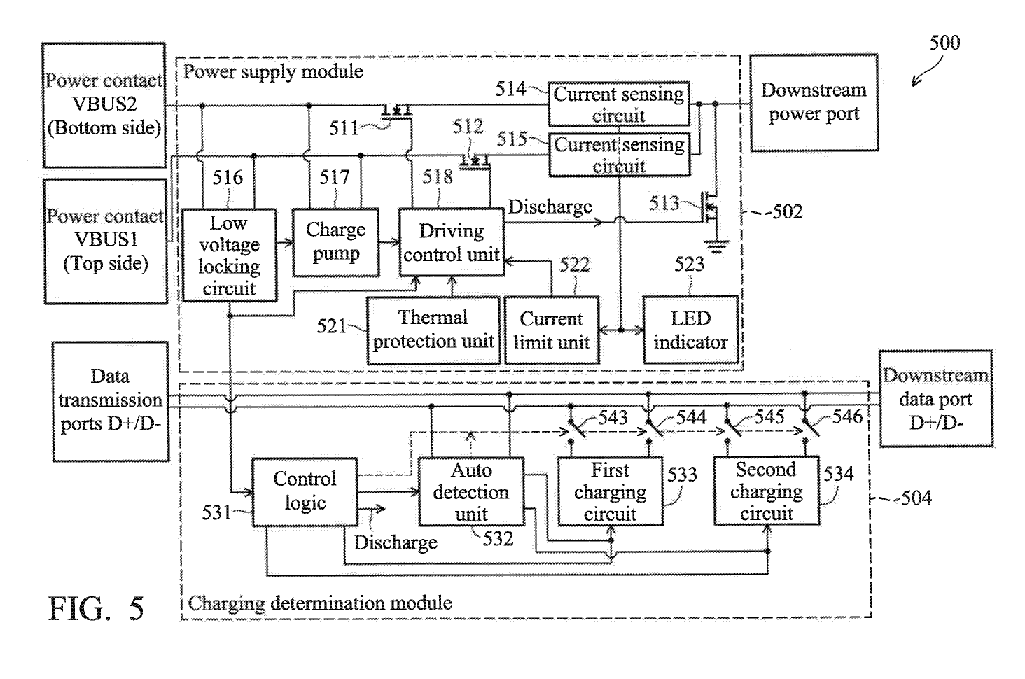

Referring to FIG. 5, a circuit diagram of another embodiment of a control chip 500 disposed in a USB connector according to the embodiment of present invention is shown. The control chip 500 has a similar circuit structure as that of the control chip 300 shown in FIG. 3. The control chip 500, however, does not comprise the signal switches 341 and 342, and the control logic 531 is not coupled to the signals paths between the data transmission contacts D+ and D− and the downstream data ports of the cable 106. Data transmission on the signal paths is therefore prevented from being disturbed by the control logic 531. When the USB connector 105 is inserted into the host connector 108 with a bottom side upward, the control logic 531 couples a predetermined charging circuit (such as the first charging circuit 533) to the downstream data ports of the cable 106. The auto detection unit 532 then detects whether the device 104 coupled to the cable 106 supports a first charging mode or a second charging mode. If the device 104 supports the first charging mode, the control logic 531 turns on the switches 543 and 544 to couple the first charging circuit 533 to the downstream data ports of the cable 106. If the device 104 supports the second charging mode, the control logic 531 turns on the switches 545 and 546 to couple the second charging circuit 534 to the downstream data ports of the cable 106, and turns off the switches 543 and 544 to decouple the first charging circuit 533 from the downstream data ports.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A connector, conforming to a data communication standard, connected to a cable, comprising:
a contact opening, comprising a plurality of first contacts on a first side for performing a data communication process, and a plurality of second contacts on a second side for performing a rapid charging process; and
a control chip, coupled between the contact opening and the cable, coupling the second contacts to a downstream power port of the cable when the second contacts of the contact opening are coupled to a host connector of a host, to perform a raid charging process.

2. The connector as claimed in claim I, wherein the first contacts comprise a first power contact, a first ground contact, a positive data transmission contact, and a negative data transmission contact, and the second contacts comprise a second power contact and a second ground contact.

3. The connector as claimed in claim 2, wherein the control chip comprises:
a first power switch, coupled between the first power contact of the contact opening and the downstream power port of the cable; and
a second power switch, coupled between the second power contact he contact opening and the downstream power port of the cable;
wherein when the second power contact is coupled to a power of the host connector, the control chip turns on the second power switch to couple the second power contact to the downstream power port to perform the rapid charging process.

4. The connector as claimed in claim 2, wherein the control chip further comprises:
a first signal switch, coupled between the positive data transmission contact and a downstream positive data port of the cable; and
a second signal switch, coupled between the negative data transmission port and a downstream negative data port of the cable;
wherein when the first power contact is coupled to a power of the host connector, the control chip turns on the first signal switch to couple the positive data transmission contact to the downstream positive data port, and turns on the second signal switch to couple the negative data transmission contact to the downstream negative data port, and
wherein when the second power contact is coupled to the power of the host connector, the control chip turns off the first signal switch to decouple the positive data transmission contact from the downstream positive data port, and turns off the second signal switch to decouple the negative data transmission contact from the downstream negative data port.

5. The connector as claimed in claim 3, wherein the control chip further comprises a charging determination module, comprising:
an auto detection unit, determining whether a device coupled to the cable supports a first charging mode or a second charging mode;
a first charging circuit, when the device supports the first charging mode, being coupled to a downstream positive data port and a downstream negative data port of the cable, and performing the rapid charging process according to the first charging mode to charge the device; and
a second charging circuit, when the device supports the second charging mode, being coupled to the downstream positive data port and the downstream negative data port of the cable, and performing the rapid charging process according to the second charging mode to charge the device.

6. The connector as claimed in claim 5, wherein the control chip further comprises:
a first switch, coupled between the first charging circuit and the downstream positive data port;
a second switch, coupled between the first charging circuit and the downstream negative data port;
a third switch, coupled between the second charging circuit and the downstream positive data port; and
a fourth switch, coupled between the second charging circuit and the downstream negative data port;
wherein the auto detection unit turns on the first switch and the second switch to couple the first charging circuit to the downstream positive data port and the downstream negative data port when the device supports the first charging mode, and turns on the third switch and the fourth switch to couple the second charging circuit to the downstream positive data port and the downstream negative data port when the device supports the second charging mode.

7. The connector as claimed in claim 1, wherein the connector further comprises a data transmission indicator, and the control chip lights up the data transmission indicator when the data transmission process is performed.

8. The connector as claimed in claim 1, wherein the connector further comprises a plurality of charging current indicators respectively corresponding to different current levels, and when the rapid charging process is performed, the control chip lights up one of the charging current indicators according to a corresponding charging current level of the rapid charging process.

9. The connector as claimed in claim 1, wherein the connector further comprises an abnormal indicator, and the control chip lights up the abnormal indicator when an abnormal high current, an abnormal low voltage, or an abnormal high temperature occurs during the rapid charging process.

10. The connector as claimed in claim 1, wherein the data communication standard is a Universal Serial Bus (USB) standard.

11. A control chip, comprising:
a charging determination module, when a plurality of first contacts on a first side of a contact opening coupled to the control chip are coupled to a host connector of a host, performing a data transmission process conforming to a data communication standard; and
a power supply module, when a plurality of second contacts on a second side of the contact opening are coupled to the host connector, coupling the second contacts to a downstream power port of a cable to perform a raid charging process.

12. The control chip as claimed in claim 11, wherein the charging determination module couples the first contacts to a downstream positive data port and a downstream negative data port to perform the data communication process.

13. The control chip as claimed in claim 11, wherein the first contacts comprise a first power contact, a first ground contact, a positive data transmission contact, and a negative data transmission contact, and the second contacts comprise a second power contact and a second ground contact.

14. The control chip as claimed in claim 13, wherein the charging determination module comprises:
a first signal switch, coupled between the positive data transmission contact and a downstream positive data port of the cable;
a second signal switch, coupled between the negative data transmission port and a downstream negative data port of the cable; and
a control circuit, when the first power contact is coupled to a power of the host connector, turning on the first signal switch to couple the positive data transmission contact to the downstream positive data port, and turning on the second signal switch to couple the negative data transmission contact to the downstream negative data port.

15. The control chip as claimed in claim 14, wherein the charging determination module further comprises:
an auto detection unit, determining whether a device coupled to the cable supports a first charging mode or a second charging mode;
a first charging circuit, when the device supports the first charging mode, being coupled to the downstream positive data port and the downstream negative data port of the cable, and performing the rapid charging process according to the first charging mode to charge the device; and
a second charging circuit, when the device supports the second charging mode, being coupled to the downstream positive data port and the downstream negative data port of the cable, and performing the rapid charging process according to the second charging mode to charge the device.

16. The control chip as claimed in claim 14, wherein when the second power contact is coupled to the power of the host connector, the control circuit turns off the first signal switch to decouple the positive data transmission contact from the downstream positive data port, and turns off the second signal switch to decouple the negative data transmission contact from the downstream negative data port.

17. The control chip as claimed in claim 13, wherein the power supply module comprises:
a first power switch, coupled between the first power contact of the contact opening and the downstream power port of the cable;
a second power switch, coupled between the second power contact of the contact opening and the downstream power port of the cable; and
a driving control unit, when the second power contact is coupled to a power of the host connector, turning on the second power switch to couple the second power contact to the downstream power port to perform the rapid charging process.

18. The control chip as claimed in claim 11, wherein the control chip lights up a data transmission indicator of a connector when the data transmission process is performed.

19. The control chip as claimed in claim 11, wherein when the rapid charging process is performed, the control chip lights up one of the charging current indicators respectively corresponding to different current levels disposed in a connector according to a corresponding charging current level of the rapid charging process.

20. The control chip as claimed in claim 11, wherein the control chip lights up an abnormal indicator disposed in a connector When an abnormal high current, an abnormal low voltage, or an abnormal high temperature occurs during the rapid charging process.
